(19) United States
(12) Patent Application Publication
(10) Pub. No.: US 2026/0058883 A1
(43) Pub. Date: Feb. 26, 2026

(54) AI/ML-BASED METHOD FOR PRODUCING A TELECOMMUNICATION PROTOCOL AUTOMATICALLY

(71) Applicant: NOKIA SOLUTIONS AND NETWORKS OY, Espoo (FI)

(72) Inventors: Mateus PONTES MOTA, Paris (FR); Alvaro VALCARCE RIAL, Garches (FR)

(21) Appl. No.: 19/104,849

(22) PCT Filed: Aug. 31, 2022
(86) PCT No.: PCT/EP2022/074151

§ 371 Date: Feb. 19, 2025

(51) Int. Cl. H04L 41/16; H04L 5/00

(52) U.S. Cl. CPC H04L 41/16; H04L 5/0044

(57) ABSTRACT

A method comprising: training a machine learning model to learn a communication protocol for a communication medium by assigning a function to control plane actions in a set of control plane actions without predefined associated function, wherein the protocol defines control-plane messages to be transmitted via the communication medium and a user-plane policy; wherein the machine learning model is configured to identify, in the set of control plane actions, a control plane action to be performed during a current transmission time interval by a protocol agent at a network node.

### TECHNICAL FIELD

Various example embodiments relate generally to a training method and training apparatus for automatically learning and generating a protocol defining control-plane messages to be used and a user-plane policy using an AI/ML-based protocol agent.

### BACKGROUND

Current communication protocols follow a set of fixed rules given by an industry standard and each hardware vendor has to build products according to these standards. However, given the large effort it takes to develop these systems, telecom equipment vendors can only implement a limited number of protocols. In the context of small private networks, current products may for example be a scaled down version of larger products. The vendors have to develop wireless networks that address the very-specific needs of dedicated or private networks (e.g., a network for an offshore windfarm has very different needs from a network to be deployed in a small university campus, or onboard of a moving vehicle). This requires designing, building and testing a new network and corresponding protocols for each target network. This cannot be done in a scalable manner when hundreds of thousands of these smaller networks have to be developed.

As an example, the conventional 5G MAC (Medium Access Control) protocol is general-purpose and although it may be possible to compare protocols according to performance, customizing new protocols for each separate customer is costly. Furthermore, searching in the space of possible protocols and deciding which protocol to use for each target network is NP-hard.

MAC protocols enable multiple nodes to share a channel. If several nodes transmit concurrently on the same resource, a collision occurs and the receiver is unable to decode the information. In low density networks, contention-based protocols perform well. But in larger more complex networks, nodes may exchange control information according to some signalling policy. This lets them coordinate and effectively use the shared data channel according to some channel-access policy.

In this context, automated protocol configuration using AI/ML (Artificial Intelligence/Machine Learning) techniques is promising since it may be able to produce protocols that are fitted to a specific requirement, traffic model or application. In particular, developing application-tailored multiple-access protocols for private networks with low signalling overhead is a challenge.

However, this is a difficult technical problem because, despite promising early results, emerging a protocol involves coordinated training across heterogenous radio nodes (i.e., base stations and user equipments). Multi-Agent techniques are needed to make sure that the learned signalling policies are properly used and applied by all nodes. Achieving this in large scenarios, is an even more daunting task.

### SUMMARY

The scope of protection is set out by the independent claims. The embodiments, examples, and features, if any, described in this specification that do not fall under the scope of the protection are to be interpreted as examples useful for understanding the various embodiments and examples that fall under the scope of protection.

According to a first aspect, a method is disclosed. The method comprises: training a machine learning model to learn a communication protocol for a communication medium by assigning a function to control plane actions in a set of control plane actions without predefined associated function, wherein the protocol defines control-plane messages to be transmitted via the communication medium and a user-plane policy; wherein the machine learning model is configured to identify, in the set of control plane actions, a control plane action to be performed during a current transmission time interval by a protocol agent at a network node.

The communication protocol may be a medium access control, MAC, protocol and the protocol agent may be a MAC agent.

The machine learning model may be configured to identify the control plane action on the basis of at least on an observation vector obtained for a current transmission time interval.

The machine learning model may be configured to identify the control plane action on the basis of one or more control plane messages received from another MAC agent at another network node.

Training the machine learning model may comprise: receiving from a training host a training feedback for a next transmission time interval; updating coefficients of the machine learning model based on the training feedback.

The training feedback may include a reward based on contributions of other protocol agents participating with the protocol agent to a multiagent reinforcement learning process, wherein a reward contribution of a protocol agent is computed based on a reward function that increases as a function of a goodput achieved by user plane transmissions through the communication medium.

The contribution to the reward of an agent implemented by a user equipment may be set for a given transmission time interval and an uplink: to a positive reward amount when an uplink data packet is received from the user equipment by a base station in response to a previous downlink control plane message; to a negative reward amount when a user equipment deletes a data packet from its transmission buffer if the data packet has not yet been received by the base station; to zero otherwise.

The contribution to the reward of an agent implemented by a user equipment may be set for a given transmission time interval and a downlink: to a positive reward amount when a downlink data packet is received from a base station by a user equipment in response to a previous uplink control plane message; to a negative reward amount when a base station deletes a data packet from its transmission buffer when the data packet has not yet been received by the user equipment; set to zero otherwise.

The machine learning model may be configured to identify in a set of a user plane actions a next user plane action to be performed by the agent on a physical layer on the basis at least of the observation vector.

The number of control plane actions in the set of control plane actions may be defined as a function of a number of user equipments associated with the network node and a number of types of control plane messages.

The method according to the first aspect may comprise: sending training data to the training host, the training data including one or more observation vectors and / or one or more control plane actions identified by the machine learning model based on the one or more observation vectors and/or one or more user plane actions identified by the machine learning model based on the one or more observation vectors.

According to a second a method for a training host associated with a plurality of protocol agents participating to a multiagent reinforcement learning process is disclosed. The method comprises: receiving training data from at least one protocol agent, the training data including state vectors and one or more control plane actions predicted by a machine learning model at the protocol agent; computing a reward on the basis of one or more control plane actions predicted respectively by the protocol agents; updating a critic machine learning model based on the reward and the state vectors, wherein the critic machine learning model is configured to generate an expected quality value based on the training data; sending a training feedback to the protocol agents, wherein the training feedback includes at least one of the expected quality value and the reward.

The reward may be based on contributions of the protocol agents, wherein a reward contribution of a protocol agent is computed based on a reward function that increases as a function of a goodput achieved by user plane transmissions through the communication medium.

According to a third aspect an apparatus is disclosed. The apparatus comprises means for performing a method comprising training a machine learning model to learn a communication protocol for a communication medium by assigning a function to control plane actions defined in a set of control plane actions, wherein the protocol defines control-plane messages to be transmitted via the communication medium and a user-plane policy; wherein the machine learning model is configured to identify, in the set of control plane actions, a control plane action to be performed during a current transmission time interval by a protocol agent at a network node.

Generally, the apparatus according to the third aspect comprises means for performing one or more or all steps of the method according to the first aspect. The means may include circuitry configured to perform one or more or all steps of the method. The means may include at least one processor and at least one memory including computer program code, the at least one memory and the computer program code being configured to, with the at least one processor, cause the apparatus to perform one or more or all steps of the method.

According to a fourth aspect an apparatus is disclosed. The apparatus comprises means for performing a method comprising: receiving training data from at least one protocol agent, the training data including state vectors and one or more control plane actions predicted by a machine learning model at the protocol agent; computing a reward on the basis of one or more control plane actions predicted respectively by the protocol agents; updating a critic machine learning model based on the reward and the state vectors, wherein the critic machine learning model is configured to generate an expected quality value based on the training data; sending a training feedback to one or more protocol agents at one or more network nodes, wherein the training feedback includes at least one of the expected quality value and the reward.

Generally, the apparatus according to the fourth aspect comprises means for performing one or more or all steps of the method according to the second aspect. The means may include circuitry configured to perform one or more or all steps of the method. The means may include at least one processor and at least one memory including computer program code, the at least one memory and the computer program code being configured to, with the at least one processor, cause the apparatus to perform one or more or all steps of the method.

One or more embodiments concern a non-transitory computer readable medium comprising program instructions stored thereon for performing one or more or all steps of a method according to the first or respectively the second aspect. The program instructions may cause an apparatus to perform one or more or all steps of a method according to the first or respectively the second aspect.

### BRIEF DESCRIPTION OF THE DRAWINGS

The accompanying drawings, which are incorporated in and constitute a part of this specification, illustrate example embodiments together with the general description given above, and the detailed description given below.

FIG. 1 is a schematic diagram illustrating a communication system according to an example.

FIG. 2 is a schematic diagram illustrating a communication system for training MAC agents according to an example.

FIG. 3 shows dataflows and protocol stacks implemented by network nodes according to an example.

FIG. 4 shows dataflows implemented by network nodes during a training phase according to an example.

FIG. 5 shows temporal aspects of a training procedure according to an example.

FIG. 6 is a block diagram showing functional blocks in a network node and a training agent according to an example.

FIG. 7 is a flow diagram illustrating a method for a MAC agent according to an example.

FIG. 8 is a flow diagram illustrating a method for a training host according to an example.

FIG. 9 is a flow diagram illustrating a method for a MAC agent according to an example.

FIG. 10 is a flow diagram illustrating a method for a training host according to an example.

FIG. 11 illustrate performances of a method for generating a communication protocol according to an example.

FIG. 12 illustrate performances of a method for generating a communication protocol according to an example.

FIG. 13 is a block diagram of an apparatus that may include a training host or a network node according to an example.

It should be noted that these drawings are intended to illustrate various aspects of devices, methods and structures used in example embodiments described herein. The use of similar or identical reference numbers in the various drawings is intended to indicate the presence of a similar or identical element or feature.

### DETAILED DESCRIPTION

Detailed example embodiments are disclosed herein. However, specific structural and functional details disclosed herein are merely representative for purposes of describing example embodiments. Accordingly, these embodiments are shown by way of illustrative examples in the drawings and will be described herein in detail so as to provide a thorough understanding of the various aspects. However, it will be understood by one of ordinary skill in the art that example embodiments are capable of various modifications and alternative forms and may be practiced without all the specific details. In addition, systems and processes may be shown in block diagrams so as not to obscure the example embodiments in unnecessary detail. In other instances, well-known processes, structures, and techniques may be shown without unnecessary detail in order to avoid obscuring the example embodiments.

Exemplary embodiments provide apparatuses, methods and computer programs for training protocol agents using an AI/ML model. Each protocol agent may be a MAC agent. Each protocol agent is a AI/ML-based protocol agent.

A training method and training apparatus configured to train a protocol agent based on an AI/ML model (e.g. AI software protocol agent) to generate a new high performing communication protocol fully from scratch and without previously agreed signalling convention and/or scenarios in a multiple-access environment is described. The learned protocol may be a one-layer or layer-specific protocol. The learned protocol may be a MAC protocol.

This learned protocol may be used for controlling access to any type of communication medium and whatever the number of network nodes requesting access to this communication medium. This learned protocol may be used for any type of link either for wireless links (including radio links, optical links, etc) or for wired links. Like existing communication protocols, the newly emerged protocol includes not only physical layer control policies (e.g., channel access policies), but also the control signalling messages needed to enable the physical layer control policies.

This learned protocol may be used for controlling access to a radio medium, such as for example a MAC-layer 6G protocol suitable for 6G networks. Instead of a human-designed Air Interface, an AI-based Air Interface (AI-AI) MAC layer is proposed for addressing the multiple channel access problem. A new MAC layer component or L2 component for multiple-access suitable for a 6G AI-based Air Interface (AI-AI) can be automatically generated and used in each network node, e.g. either in a base station or in user equipments. This component can be used with existing L1 solutions (e.g. end-to-end PHY learning, MU-MIMO decoding, DeepRX, DPD, pilot-less transmissions, etc.) to build a fully AI-native Air Interface. The following benefits may be obtained:
Optimization of goodput and/or other application-specific KPIs, such as latency, signalling overhead and/or energy efficiency in customer-specific multiple-access wireless scenarios;
Automation of the design-development-testing cycle for wireless MAC protocols. This cycle will be replaced by an automated training procedure;
Reduction of the development time of novel 6G MAC protocols as a fast training protocol routine may replace the slower traditional design-implement-test cycles.

The AI/ML model is used to implement a signalling policy by predicting one or more control plane actions and one or more associated user plane actions to be performed. The predicted control plane action is selected in a set of control plane actions defining a control plane action space for the protocol agent. The predicted user plane action is selected in a set of user plane actions defining a user plane action space for the concerned protocol agent.

The protocol agents learn to effectively use the control plane message while also learning how to effectively control the user plane traffic. The AI/ML agent model is trained to learn how to assign a meaning and/or function to control-plane messages and to learn a user-plane policy with which to control (e.g. steer) user-plane traffic (i.e. when to do a transmission, or when not to do it). For assigning a function to a control-plane message, the AI/ML agent model learns when to send which control-plane message having initially no predefined meaning based on input data (e.g. one or more observation vectors, received and/or sent control plane and/or user plane messages) of the AI/ML agent model.

To define the control plane space, the bitlength of the learned control plane messages or the number of control plane messages (e.g. how many types of control plane messages are needed) in the control plane space is defined. An identifier is assigned to each control plane message without the need to assign a meaning or function such that, before training, the control plane actions have initially no agreed meaning or function between the network entity (e.g. a base station) and the user equipment. This provides a way of searching the signalling policy that reduces signalling overhead.

Each control plane action in the set of control plane actions could a priori be used in all scenarios until the AI/ML model has been sufficiently trained to be able to determine when to execute which action. Once the AI/ML model is trained, the protocol agent uses the trained AI/ML model to predict which action(s) has (have) to be executed. without explicitly assigning a meaning to the actions during training. Then, after training, the meaning of each action will have been acquired. For example, the agents will have learned that receiving action 1 means the right to transmit, receiving action 2 means acknowledgement of last transmission, etc. These meanings and/or function, as well as other unforeseen ones, were not known before training, but they have been learned during training.

A Multi-Agent technique with reinforcement learning is used to make sure that the learned signalling policies are properly understood by all protocol agents in the network nodes that request access to the same communication medium. The method may be based on cooperative Multiagent Reinforcement Learning (MARL) and on Learning-to-Communicate (L2C) techniques for training the protocol agent to emerge a new communication protocol. This method replaces the human-defined protocols with protocols fully emerged by intelligent agents trained in a Reinforcement Learning (RL) fashion.

This method may be used to emerge protocols in multiple-access scenarios where several sensors periodically need to transmit information or in scenarios where the traffic is more uniformly distributed, providing different protocols that maximizes the goodput in each scenario.

A training host is used to train the protocol agents, exploiting the Centralized Training/Decentralized Execution (CTDE) paradigm. In this paradigm, the protocol agents exchange information with a central entity, referred to herein as the training host, accelerating the training and helping to deal with multi-agent issues while also providing the radio nodes with learning signals that would not be available in a decentralized scheme.

During the training the different protocol agents at the network nodes (UEs and BS) interact with one another through the training host by sending training data and receiving training feedback from the training host. The training feedback may include a reward, a quality value or parameters of a centrally learned model. The training data of a protocol agent may include one or more observation vectors used by the protocol agent and/or one or more control plane actions predicted by the protocol agent and/or one or more user plane actions predicted by the protocol agent.

Instead of coding the protocol agent of the radio nodes as an expert system the agent is replaced at each network node by an intelligent software agent in the Reinforcement Learning (RL) sense, herein called protocol agent. Unlike existing approaches, there is no signalling convention pre-agreed by the network nodes. Instead, all network nodes (i.e., UEs and BSs) implement a protocol agent that will cooperatively learn and discover a new and effective signalling convention. Several MARL algorithms may be used to train the protocol agents for example MADDPG (Multi-Agent Deep Deterministic Policy Gradient), MAPPO (Multi-Agent Proximal Policy Optimization) or QMIX.

This allows to produce a customized communication protocol without pre-agreed conventions or policies, in an automated fashion and at the same time to optimize the control-plane. For example, no pre-agreed conventions need to be defined with respect to rules or policies for accessing to the communication medium, functions of signalling actions that are needed to control this access or a temporal order of the signalling actions to be performed. Also, the resulting communication protocol is not constrained by conventions imposed by a standard and may be much simpler than existing standardized protocols.

A fully novel signalling policy (i.e., the protocol's control plane) and physical channel-access policy (i.e., the protocol's user plane) emerges by the simultaneous training of the AI/ML models of all protocol agents in the network nodes while optimizing the goodput in multiple-access scenarios. The proposed method emerges a multiple-access protocol best suited to a given scenario, where differences in scenarios may include different traffic dynamics, different number of UEs or different signalling load constraints. This method reduces the costs associated with the definition, implementation, testing and validation of these protocols, while at the same time improving network performance and reducing signalling overhead.

Various aspect of the training methods and training apparatuses will now be described in the typical example case of a radio network but are applicable in a similar manner for other type of networks or communication medium. In the examples disclosed in details, the protocol agent is a MAC agent and the learned communication protocol is a MAC protocol.

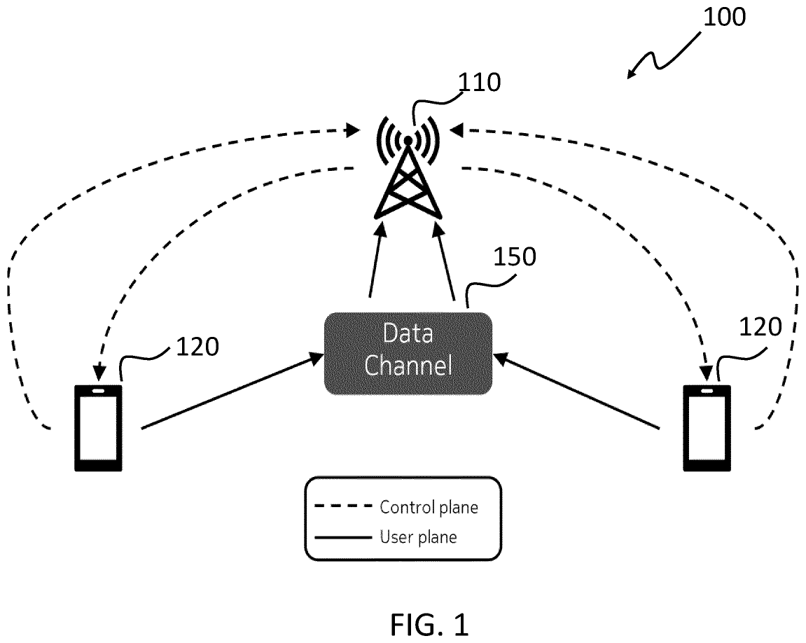

FIG. 1 illustrates an example of a communication system 100 in a radio network including several networks nodes 110, 120: at least one base station 110 and several user equipments 120. Each user equipment 120 may send/receive control plane messages to/from the base station 110. Each networks node 120 may send/receive user plane messages to/from another network node 110, 120. The user plane messages and control plane messages are transmitted through the radio communication medium. The user plane messages and control plane messages may be transmitted through one or more communication channels 150 defined for the radio communication medium.

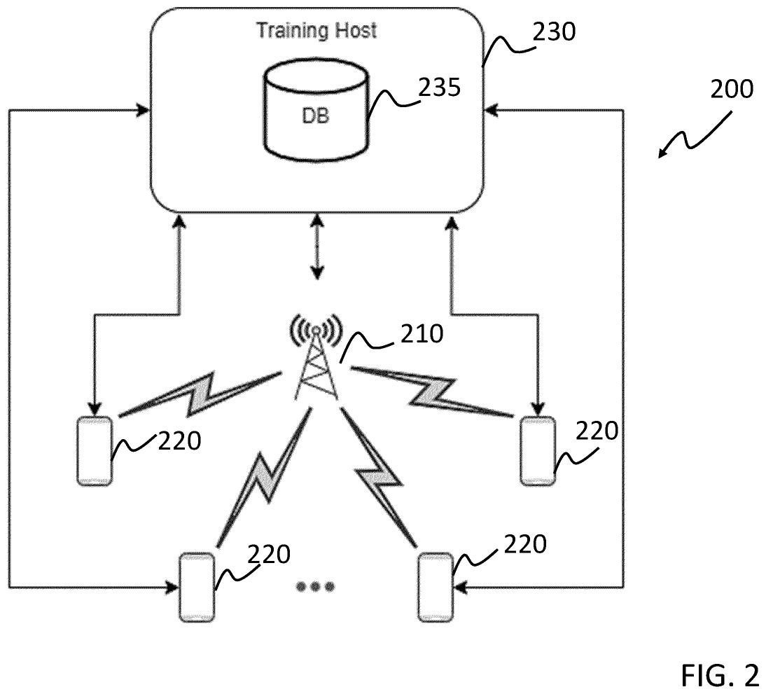

FIG. 2 shows an example of a communication system 200 in a radio network including at least one base station 210, several user equipments 220 and a network node configured to implement a training host 230 during a training phase. The training host 230 is configured to communicate with the base station 110 and all the user equipments 220 and may be included in the base station 210 or in any another network entity configured to communicate with the base station 210 and all the user equipments 220. The training host 230 uses a database 235 for storing training data.

The base station 210 and each of user equipments 220 include a MAC agent configured to train a respective ML model. Each ML model in a network node is configured to predict one or more actions to be performed by this network node, i.e. by the base station or the concerned user equipment. During the training phase, each MAC agent is configured to communicate with the training host 230. Once the ML models are trained, the training host 230 is no more necessary and the base station 210 and each of user equipments 220 are configured to predict one or more actions to be performed using their respective trained model.

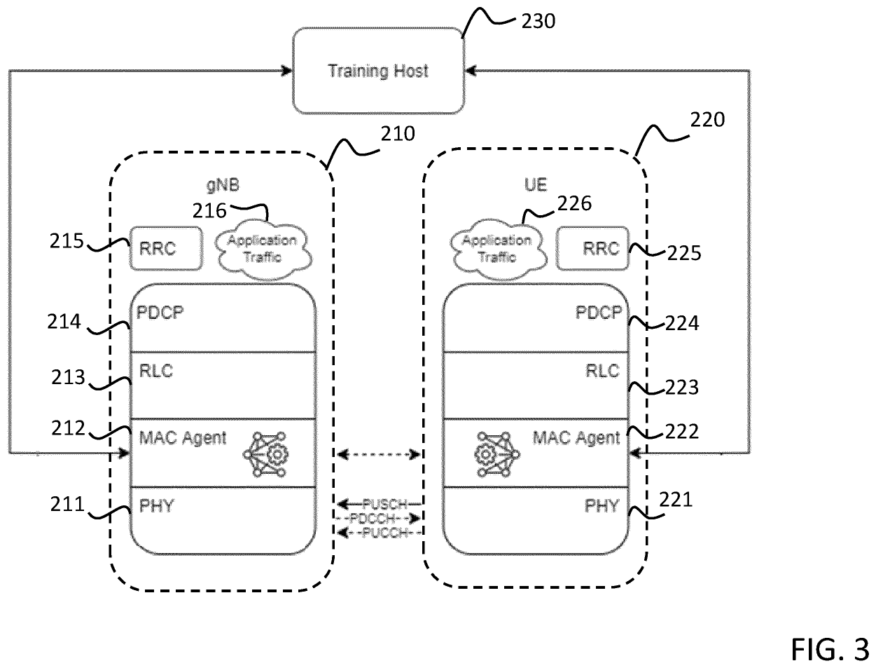

FIG. 3 shows dataflows and protocol stacks implemented by the network nodes 210 and 220.

As shown in FIG. 3, the base station 210 includes a physical layer module 211, a medium access control (MAC) layer implemented by a MAC agent 212, a radio link control (RLC) module 213, a packet data convergence protocol (PDCP) module 214, a radio resource control (RRC) module 215 and software applications 216 generating data traffic.

Likewise, the user equipment 220 includes a physical layer module 221, a MAC layer corresponding to a MAC agent 222, a RLC module 223, a PDCP module 224, a RRC module 225 and software applications 226 generating data traffic.

The MAC agent 212 is configured to communicate through the radio medium in downlink or uplink direction with the corresponding MAC agent 222 at the user equipment 220. The MAC agent 212 and the MAC agent 222 communicate using protocol data units (PDUs) 26. A MAC agent 212, 222 may generate PDU headers as control plane messages and encapsulate the upper-layer Service Data Units (SDUs) into Protocol Data Units (PDUs) by adding a header to the SDUs. The content of these headers are bit strings and their meaning may be determined during the learning phase.

The physical layer module 211 is configured to communicate through the radio medium in downlink or uplink direction with the corresponding physical layer module 221 at the user equipment 220 through one or more physical channels (e.g. PUSCH, PDCCH, PUCCH, etc). A physical layer module 211, 221 may uses PDU to transmit user plane messages corresponding to user data traffic.

Each of the MAC agents 212, 222 is an intelligent agent that can be trained to communicate with another MAC agent using reinforcement learning or similar techniques. The training may take many forms. For example, the MAC agent 212 may use deep learning techniques by means of a ML model implemented as a neural network or deep neural network. Tabular methods may be appropriate in small state spaces to provide fast convergence to learn simple MAC protocols (e.g. sensor networks). Deep learning techniques are typically more computationally expensive but may provide more degrees of freedom to learn complex protocols (e.g. cellular networks).

As explained by reference to FIG. 2, during the training phase, each MAC agent 212, 222 is configured to communicate with the training host 230.

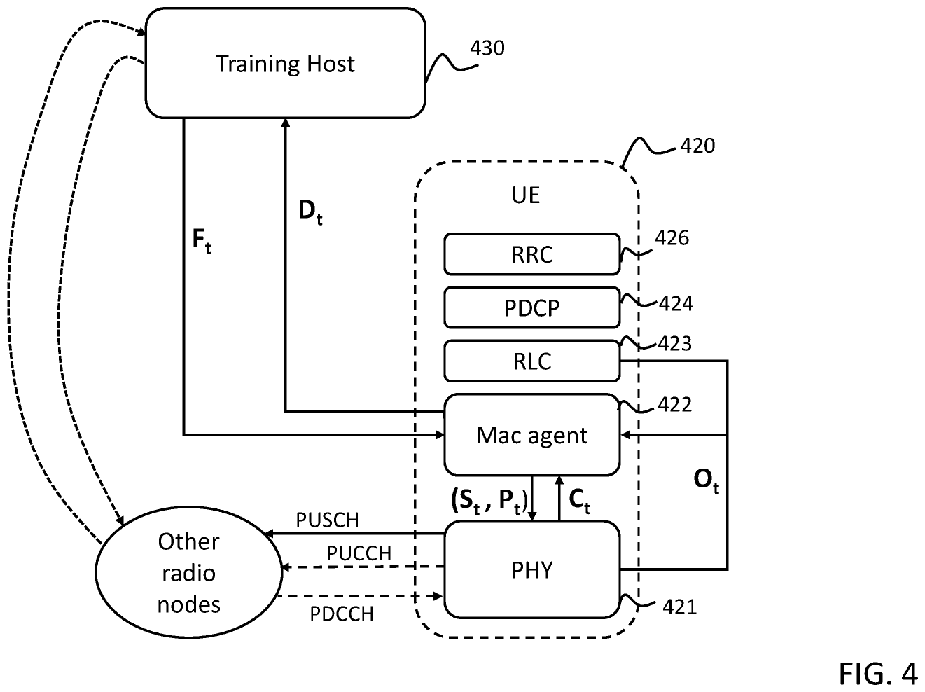

FIG. 4 illustrates dataflows occurring during a training phase between a MAC agent 422 of a network node 420 (e.g. a UE), a training host 430 and other networks nodes 410 (e.g. a base station and other UEs).

Like for FIG. 3, the network node 420 includes a physical layer module 421, a MAC agent 422, a RLC module 423, a PDCP module 424 and a RRC module 425.

The MAC agent 422 receives as input from other modules of the network node 420, one or more values of one or more observation parameters Ot. These values of the observation parameters may be received for example from the physical layer module 421 or the RLC module 423 as represented by FIG. 4.

The MAC agent 422 generates one or more actions (user plane actions Pt and/or control plane actions St) corresponding to messages to be transmitted through the radio medium using the physical layer module 421, using one or more communication channels (e.g. PUSCH, PUCCH, PDCCH).

The physical layer module 421 may also receive input control plane or user plane messages from at least one of the other radio nodes 410. Received control plane messages Ct may be transmitted by the physical layer module 421 to the MAC agent 422 for processing.

The MAC agent 422 generates training data DI sent to the training host 430 and receives as input a training feedback Ft from the training host, where the training feedback Ft is used by the MAC agent 422 to update its ML model.

### Training Procedure

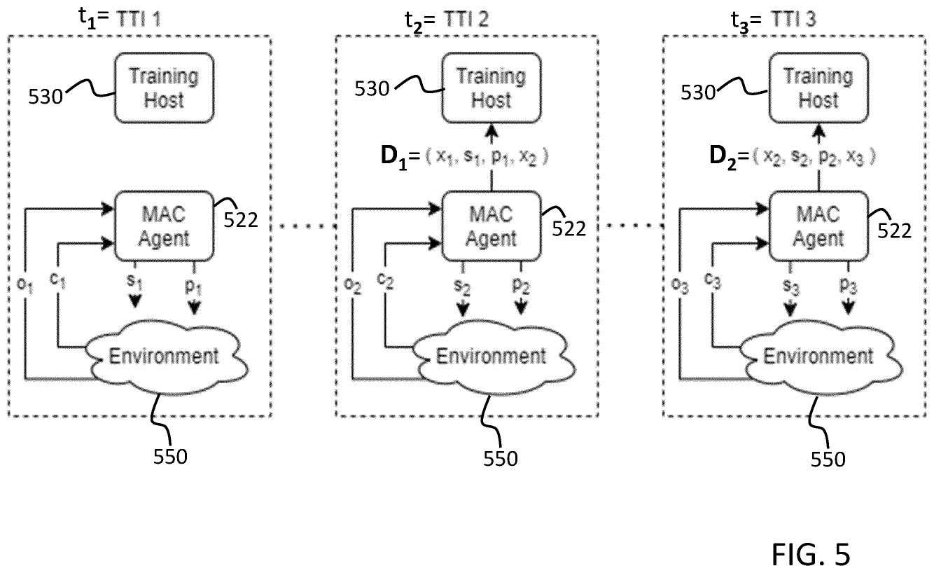

FIG. 5 shows temporal aspects of the training procedure performed by each MAC agent according to an example.

The training method may include repetitive steps performed at each transmission time interval (TTI) (e.g. t1=TTI 1, t2=TTI2, t3=TTI3) as represented by FIG. 5. The environment 550 corresponds here to the radio medium and the one or more communication channels, including control channels (e.g. PDCCH, PUCCH) and shared channels (e.g. PUSCH, PDSCH) for user plane that may be established through the radio medium.

On every Transmission Time Interval (TTI) t each MAC agent 522 obtains an observation oₜ and receives a control message cₜ, which may be used to form the agent state vector xₜ. Then using its ML model, the MAC agent determines and performs a PHY action pₜ and a signalling action sₜ corresponding respectively to messages to be transmitted through the radio medium. Then it receives a new observation oₜ₊₁ and the new control message cₜ₊₁. Finally the MAC agent sends training data Dₜ to the training host 530 so that training host 530 can calculate the reward rₜ₊₁ for the next TTI. The tuple Dₜ=(xₜ, pₜ, sₜ, rₜ₊₁, xₜ₊₁) is denoted as a transition tuple of the underlying Markov Decision Process (MDP) and the control messages is the signalling action of another MAC agent, or other MAC agents, taken in the previous time step.

Each observation vector o₁, o₂, o₃ is generated locally by the network node and relates to the environment, e.g. to one or more communication channel through the radio medium. An observation vector may include one or more values of one or more observation parameters. An observation parameter may for example be a state parameter, a configuration parameter, a performance indicator.

A multi-agent Actor-Critic method may be used during the training phase. An Actor-Critic method is a Temporal Difference (TD) version of Policy gradient method. An Actor-Critic method uses two AI/ML models (e.g. neural networks): the actor model and the critic model. The actor model identifies which action should be performed and the critic model provides the actor training feedback to indicate how good was the identified action and how actor model should be adjusted. After each action selection, the critic model evaluates the new state to determine whether things have gone better or worse than expected based on a TD error.

The document R. Lowe, Y. I. Wu, A. Tamar, J. Harb, P. Abbeel and I. Mordatch, “Multi-agent actor-critic for mixed cooperative-competitive environments,” in Proceedings of the 31st International Conference on Neural Information Processing Systems, 2017 discloses aspects of a multi-agent actor-critic method.

In the context of the generation of a MAC protocol, an actor model is used by each MAC agent in a network node (UE or BS) and the critic model is used in a training host. An actor model receives as input an input vector including an observation vector and generates as output an output vector identifying actions to be performed by the concerned network node. A critic model receives as input an input vector including the actions identified by the actor models and generates as output a Q-value (quality value) evaluating the quality of the actions identified by the actor models of the MAC agents.

Each MAC agent (BS side and UE side) executes an action every Transmission Time Interval (TTI). An action may be defined as a tuple that includes one user plane action and one control plane action. The training host collects training data, which may include of observation and/or action and/or reward histories, calculates the reward (goodness of the most recent actions), processes this information and sends the reward to the MAC agents.

The training of the neural networks may be done at the training host and coefficients of the neural networks are sent to the MAC agents by the training host or the neural networks can be updated at the MAC agents on the basis of the reward or quality value computed centrally by the training host.

For each actor model, a user plane action space, a control plane action space and observation space is defined. In each network node (UE or BS), an actor model may be used for uplink transmissions and another actor model may be used for downlink transmissions. The training of the MAC agents for the uplink transmissions may be performed independently and separately from the training of the MAC agents for the downlink transmissions.

For simplicity and without loss of generality, example embodiments where actor models of MAC agents at a base station and UEs are trained to produce a MAC protocol for an uplink transmission task will be described in detail. In this example embodiment, only UEs can transmit data and, as such, only they have physical layer actions. On the other hand, both UEs and the base station can send signalling messages to each other. Other embodiments of the invention may attempt to produce protocols for both uplink and downlink data transfer tasks.

### Physical Layer Action Space

For each MAC agent a physical layer action space (also designated herein as the PHY action space or user plane action space) is defined as a set of user plane actions among which the prediction performed by the MAC agent occurs. There may be a physical layer action space for the uplink (UL) and another physical layer action space for the downlink (DL). All the network nodes may have the same physical layer action space(s).

For example for uplink transmission, all UEs may have a first physical layer action space and all base stations may have a second physical layer action space, distinct from the first physical layer action space.

For example for downlink transmission, all UEs may have a third physical layer action space and all base stations may have a fourth physical layer action space, distinct from the third physical layer action space.

A user plane action may concern the transmission of one or more protocol data units (PDUs) on an uplink channel (e.g. ULSCH, Uplink Shared Channel) or respectively a downlink channel (e.g. PDSCH, Physical Downlink Shared Channel). The packet data units may be stored in an uplink buffer or respectively a downlink buffer before transmission.

Let AP_{UE} denote the set of user plane actions corresponding to the physical layer action space of a UE. This set of user plane actions is known a-priori and defined by the physical API (Application Program Interface) configured for triggering the execution of these user plane actions. Each action is identified within the set of user plane actions by an identifier PUE.

The actions in the PHY action space is imposed by the underlying physical layer and used by the MAC agents. For example, in a multiple-access scenario, APUE may include the following actions:
Action p_{UE}=0: Do nothing
Action p_{UE}=1: Transmission through the ULSCH of the next buffered MAC PDU;
Action p_{UE}=2: Removing a MAC PDU from the uplink buffer.

### Control Plane Action Space

For each MAC agent a control plane action space (also designated herein as the signalling action space) is defined as a set of control plane actions among which the prediction performed by the MAC agent occurs. There may be a control plane action space for the uplink (referred to herein as the UL signalling action space) and another control plane action space for the downlink (referred to herein as the DL signalling action space). All the network nodes may have the same control plane action space(s).

For example for uplink transmission, all UEs may have a first control plane action space and all base stations may have a second control plane action space, distinct from the first control plane action space.

For example for downlink transmission, all UEs may have a third control plane action space and all base stations may have a fourth control plane action space, distinct from the third control plane action space.

A control plane action (also referred to as a signalling action) may concern the transmission of one or more signalling messages or service data units (SDUs) on an uplink channel (e.g. PUCCH, Uplink Control Channel) or respectively a downlink channel (e.g. PDCCH, Physical Downlink Control Channel).

Let ASDL denote the set of control plane actions corresponding to the signalling action space of a base station for the downlink and ASuL denotes the set of control plane actions corresponding to the signalling action space of a base station. Two remote MAC agents may communication in the downlink and uplink respectively. The signalling actions are predicted by the AI/ML model of a MAC agent and passed on to the physical layer for transmission through the physical communication medium to the endpoint as a control-plane message.

The cardinality of the signalling action space may be defined in terms of the vocabulary size, i.e., number of possible control plane messages, which in turn depends on the number of bits used for the control plane messages.

The DL and UL signalling action space may have different cardinalities. The DL signalling action space may depend on the number of UEs to be managed by a base station and/or the number of types of control plane messages (e.g. signalling messages). Since the number of UE may vary and to address scalability concerns, there may be structured actions with a UE index and a signalling message type index associated to each action. The UE index is first selected and then the signalling message type index is selected. In another embodiment, the agents may be trained for a maximum number of UEs and then, UE masking may be used when the deployment scenario has less UEs.

For example, when considering control messages of one bit for the UL, one bit for the DL and 2 bits for the UL, with 2 UEs and a base station, only two types of signalling UL actions may be used for each UE:
Action S_{UL}=0: Send 0
Action S_{UL}=1: Send 1.

For the DL, only four signalling DL actions may be used by the base station to encode two types of signalling DL actions per UE:
Action S_{DL}=0: Send 0 for UE 1 and 0 for UE 2
Action S_{DL}=1: Send 0 for UE 1 and 1 for UE 2
Action S_{DL}=2: Send 1 for UE 1 and 0 for UE 2
Action S_{DL}=3: Send 1 for UE 1 and 1 for UE 2

The idea here is the absence of a-priori meaning for these signalling messages. Each signalling action is identified with an identifier without having to assign an interpretation or meaning to the signalling action. For example, for the uplink, only the number of control messages needs to be defined and for the downlink, the number of UEs and the number of control messages per UE is defined. An identifier is then assigned to each control message based on a number of bits to be used for the control messages. But no meaning, function or use is defined initially for the control messages of the action space.

Consequently, the MAC agents will have to explore different interpretations of these messages in a coordinated manner during the training of their respective models. This avoids embedding pre-conceptions and biased human intuitions about which information to convey into the control-plane. Moreover, it provides a way of producing protocols with different signalling requirements.

### UE Observation Space

A MAC agent at the UE uses local observations to predict the action to be performed. Heterogeneous UE-side observations may be used. For example, observation parameters such as RSRP, RSRQ, HARQ state, etc, may be used. A possible embodiment of the UE observation space for uplink transmission could be as simple as the current number of SDUs in its uplink transmission buffer. In this case, the observation space for a UE MAC agent is defined based on the number of PDUs to be sent in the UE transmission buffer:
Q_{UE}=integer number in the interval between 0 and the maximum buffer capacity

### BS Observation Space

A MAC agent at the BS may use other observation parameters available at the BS side to predict the actions to be performed. For example, observation parameters like UE context, RRC states, HARQ statistics, CSI reports, etc, may be used. For simplicity a light observation space for a simple embodiment of a BS in a network with N UEs could be:
O_{BS}=0: Idle state;
O_{BS}=n: reception of one PDU from UE n;
O_{BS}=n+1: energy detected in the communication channel, but the BS could not decode it.

### Training Data, Training Feedback and Reward

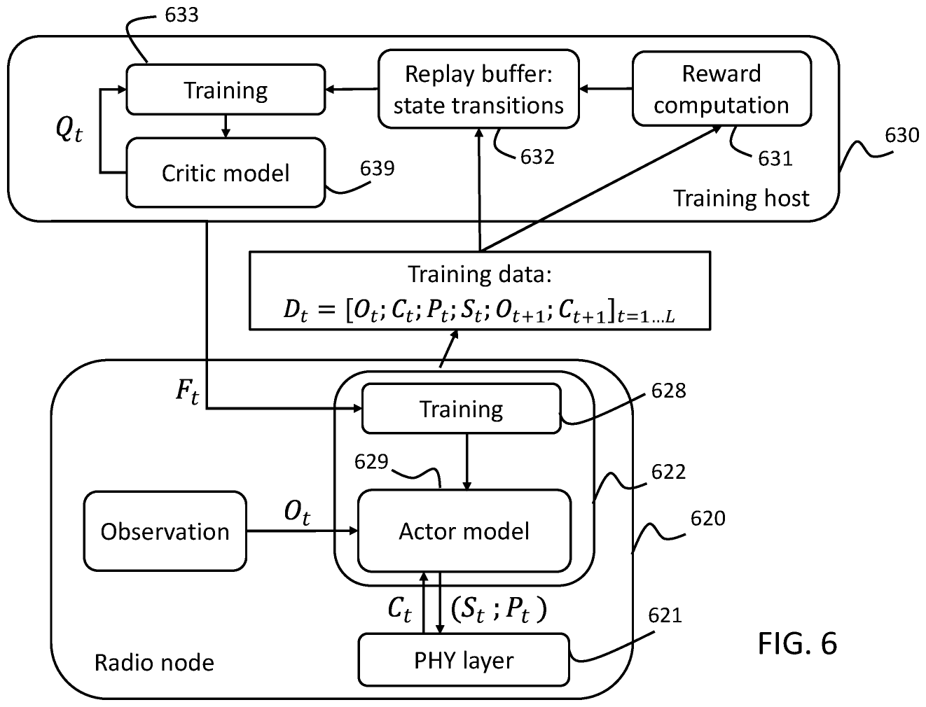

FIG. 6 shows a block diagram showing the relationships between the data used during the training phase and functional blocks in the training host 630 including a critic model 639 and the network node 620 including an actor model 629 for a MAC agent.

The training host may include a reward computation module 631 configured to compute a reward Rₜ. The training host may include a replay buffer 632 for storing state transitions of MAC agent based on received training data Dₜ, where the state transitions are used as input to the critic model 639.

The training host 630 may also include a centralized actor model (not represented) for each MAC agent trained by the training host 630. The training host may include a training module 633 for training the critic model and/or centralized actor models (not represented).

The network node 620 is a radio node and may be a UE or BS (e.g. gNB). If the radio node 620 is a UE, then the messages sent by the MAC agent 622 are UL messages and the received messages are DL messages. If, on the other hand, the radio node 620 is a gNB, the sent messages are DL messages and the received messages are UL messages.

The network node 620 may include a training module 628 for training the local actor model 629.

At a given TTI t, the MAC agent 622 sends training data Dₜ to the training host 630 630. The training data may be sent at each TTI, or based on other periodicity or on request of the training host 630.

The training data Dₜ may include:
One or more observation vectors Oₜ, Oₜ₊₁, . . . generated by the network node 620 for one or more TTI;
One or more control plane actions Sₜ identified by the actor model 629 and performed by the network node 620;
One or more user plane actions Pₜ identified by the actor model 629 and performed by the network node 620;
One or more control plane actions corresponding to signalling messages Cₜ, Cₜ₊₁, . . . received by the network node 620;

At a given TTI t, each MAC agent 622 may send training data Dt to the training host 630 and may receive a training feedback Ft from the training host 630. The training feedback is used by the MAC agent 622 to update its ML model 629.

The training feedback may include a reward given by Rₜ, which is determined by taking into account the contributions to the reward of each UE and is calculated by the training host 630 since the reward depends on all agents.

The reward may be computed based on the training data received from the MAC agent 622, especially based on the user plane actions and/or control plane actions performed by the MAC agent 622. All MAC agent 622s receive the same reward to incentivize the emergence of cooperative protocols.

The contribution to the reward of a MAC agent 622 implemented by a user equipment may be set for a given transmission time interval and an uplink as follows:
to a positive reward amount +ρ when an uplink data packet is received from the user equipment by a base station in response to a previous downlink control plane message;
to a negative reward amount −ρ when a user equipment deletes a data packet from its transmission buffer if the data packet has not yet been received by the base station.
set to zero otherwise.

Likewise, the contribution to the reward of a MAC agent 622 implemented by a user equipment may be set for a given transmission time interval and a downlink as follows:
to a positive reward +ρ amount when a downlink data packet is received from a base station by a user equipment in response to a previous uplink control plane message;
to a negative reward −ρ amount when a base station deletes a data packet from its transmission buffer when the data packet has not yet been received by the user equipment.
set to zero otherwise.

The reward computed by the training host 630 may be the sum of the contribution to the reward of the UEs. A reward may be computed for the uplink transmission and another for the downlink transmissions. This choice of such a reward indirectly optimizes for goodput while providing good learning signals for the MAC agent 622s. The total reward may be transmitted to all the MAC agent 622s or used by the training host 630 to train and update the critic model 639.

The training feedback Fₜ may include an expected Q-value Qₜ computed by the critic model 639 at the training host 630.

The training feedback Fₜ may include coefficients of a centrally trained actor model 635 trained by the training host 630 and corresponding to the actor model 629 of the MAC agent 622. There may be one centrally trained neural network for each MAC agent 622.

The RL training procedure may be the Multi-Agent Deep Deterministic Policy Gradient (MADDPG) (see for example, R. Lowe, Y. I. Wu, A. Tamar, J. Harb, P. Abbeel and I. Mordatch, “Multi-agent actor-critic for mixed cooperative-competitive environments,” in Proceedings of the 31st International Conference on Neural Information Processing Systems). In the MADDPG, each agent has its own policy network, also referred to as the actor network, which outputs an action of the agent given its state. Each agent also has a centralized critic model, which outputs the Q-value given the actions and states of all agents. The expected Q-value, Q (xₜ, aₜ), can be understood as how good it is to take an action aₜ a in a given state xₜ, in terms of expected reward. The critic model is only used during centralized training.

The critic model 639 may be updated using the squared mean of the Temporal-Difference Error, which can be understood as the difference between the expected Q-value and the observed Q-value (taking into consideration the received reward) that is computed by the training module 633 of the training host.

The actor neural network is used as the policy function and only the local agent state and action may be used as inputs. The actor neural network parameters are updated in the direction of the critic, by using the sampled deterministic policy gradient defined based on the expected Q-value.

In a multi-agent system, the following key techniques may be used to improve the training and performance of the multi-agent systems.

CTDE (Centralized Training Decentralized Execution) may be used to improve the training, while also enabling a reward function that considers network-wide metrics or different metrics that would not be available during decentralized execution.

MAC agents may have memory to avoid the problem of Partial Observability, since the MAC agents do not have access to the observations of other MAC agents. Techniques to deal with this may include memory-capable neural networks such as Long Short-Term Memories (LSTMs), Gated Recurrent Units (GRUs) or using a state representation that contains past observations and actions.

The received control plane messages and the observation vector may one-hot-encoded to be directly usable as input state vector to the neural network.

In addition, the training algorithm may use at least one of the two additional techniques. These additions may be useful to learn in more challenging scenarios and are:
D2RL (Deep dense architecture for reinforcement learning): this technique concatenates the input of the neural networks (state or state-action pair) before each hidden layer, but not before the output layer. These dense connections improve the learning algorithm (See for example, S. Sinha, H. Bharadhwaj, A. Srinivas and A. Garg, “D2rl: Deep dense architectures in reinforcement learning,” arXiv preprint arXiv:2010.09163, 2020).
Reward standardization: when sampling a batch of state transitions from the replay buffer storing for each actor agent an history of state transitions between a current state vector and next state vector, the rewards sampled are normalized by subtracting the mean over the batch and dividing by the standard deviation of the rewards on that batch and the normalized reward is used to update the critic model.

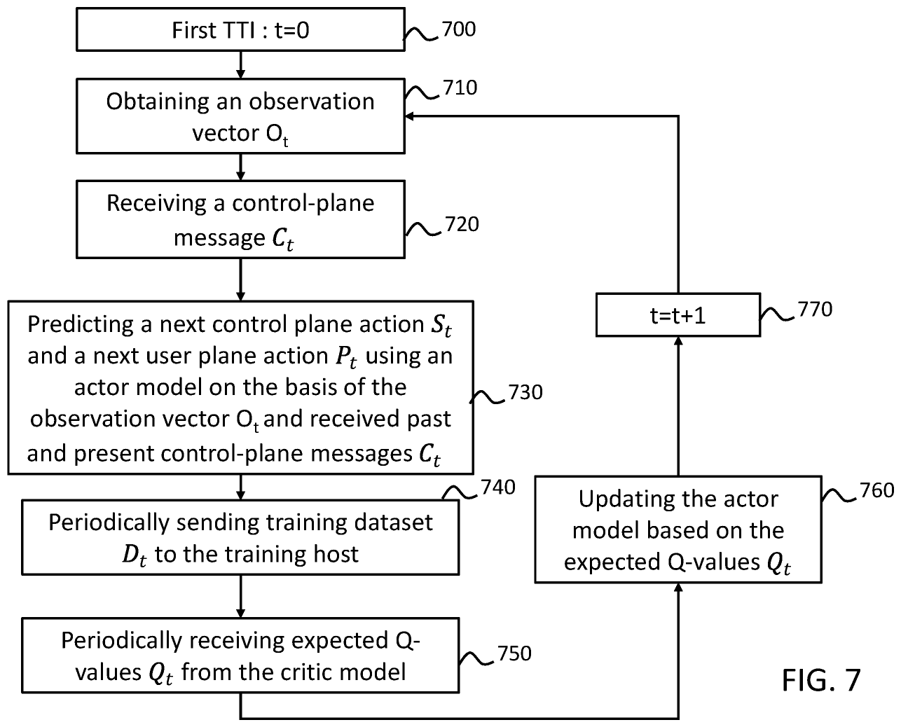

FIG. 7 shows a flow chart of a training procedure performed by a MAC agent and its actor model.

At step 700, the method starts with the initialization of the time index t=0.

At step 710, an observation vector Oₜ is obtained.

At step 720, a control plane message is received Cₜ.

At step 730, a next control plane action St and a next user plane action Pt are predicted using the actor model on the basis of the current observation vector Oₜ and one or more past control-plane messages received at former steps 720 and the current control-plane messages Ct.

At step 740, the MAC agent periodically sends training dataset Dₜ to the training host. The execution of step 740 may occur after one or more execution of steps 710 to 730.

At step 750, the MAC agent periodically receives at least one expected Q-value Qt from the critic model.

At step 760, the MAC agent updates the actor model on the basis of the at least one expected Q-value Qt received from the critic model. The execution of step 740 may occur after one or more execution of steps 710 to 730. The execution of step 740 may or not occur at the same periodicity than the step 750.

At step 770, the time index is incremented and step 710 is executed again after step 770.

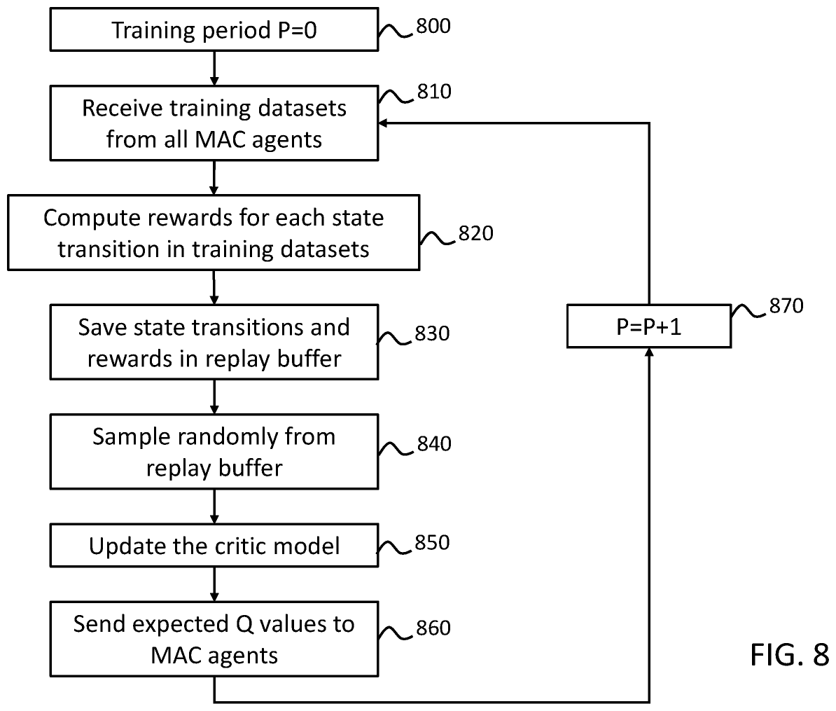

FIG. 8 shows a flow chart of a training procedure performed by a training host for a critic model.

At step 800, a training period index is initialized to zero.

At step 810, training datasets are received from all MAC agents, a training dataset including a state vector for a current time index and a state vector for a next time index thereby defining a state transition. State transitions are stored in a replay buffer.

At step 820, a reward is computed for each state transition.

At step 830, the rewards are stored in the replay buffer.

At step 840, the replay buffer is randomly sampled to extract a batch of state transitions.

At step 850, the sampled state transitions and sampled rewards obtained at step 840 are used by a training module to train and update the critic model and generate an expected Q-value using the critic model.

At step 860, each expected Q-value computed at step 850 for a MAC agent is sent to each concerned MAC agent.

At step 870, the index period is incremented and step 800 is executed again after step 870.

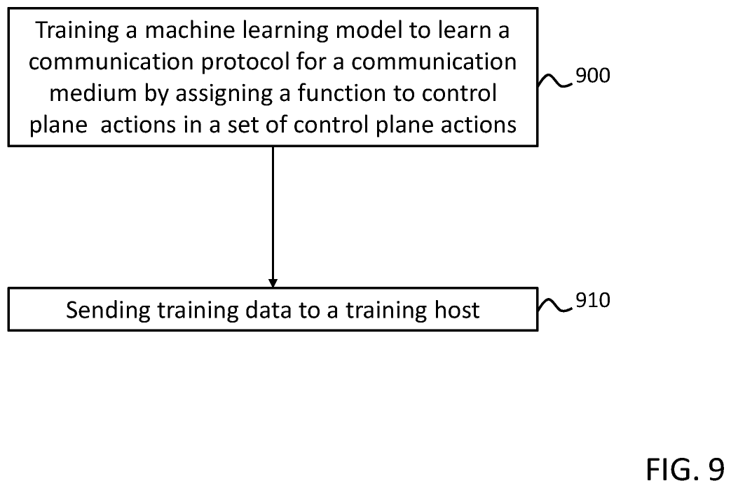

FIG. 9 shows a flow chart of a method performed by a protocol agent using an actor model. The protocol agent may be a MAC agent.

At step 900, a machine learning model is trained to define a communication protocol for a communication medium by assigning a function to control plane actions defined in a set of control plane actions. The protocol defines control-plane messages to be transmitted via the communication medium and a user-plane policy. The control plane actions in the set of control plane actions have no predefined associated function before the training starts. The number of control plane actions in the set of control plane actions may be defined as a function of a number of user equipments associated with the network node and a number of types of control plane messages.

The machine learning model may be configured to identify, in the set of control plane actions, a control plane action to be performed during a current transmission time interval by a protocol agent at a network node. The communication protocol may be a MAC protocol.

The machine learning model may be configured to identify the control plane action on the basis of at least on an observation vector obtained for a current transmission time interval.

The machine learning model may be configured to identify the control plane action on the basis of one or more control plane messages received from another MAC agent at another network node.

The machine learning model may be configured to identify in a set of a user plane actions a next user plane action to be performed by the agent on a physical layer on the basis at least of the observation vector.

Training the machine learning model may comprise a step of receiving from a training host a training feedback for a next transmission time interval. Training the machine learning model may comprise a step of updating coefficients of the machine learning model based on the training feedback.

The training feedback may include a reward based on contributions of other protocol agents participating with the protocol agent to a multiagent reinforcement learning process. The contribution to the reward of a protocol agent may be computed based on a reward function that increases as a function of a goodput achieved by user plane transmissions through the communication medium.

At step 910, training data are sent to the training host. The training data may include one or more observation vectors. The training data may include one or more control plane actions identified by the machine learning model based on the one or more observation vectors. The training data may include one or more user plane actions identified by the machine learning model based on the one or more observation vectors.

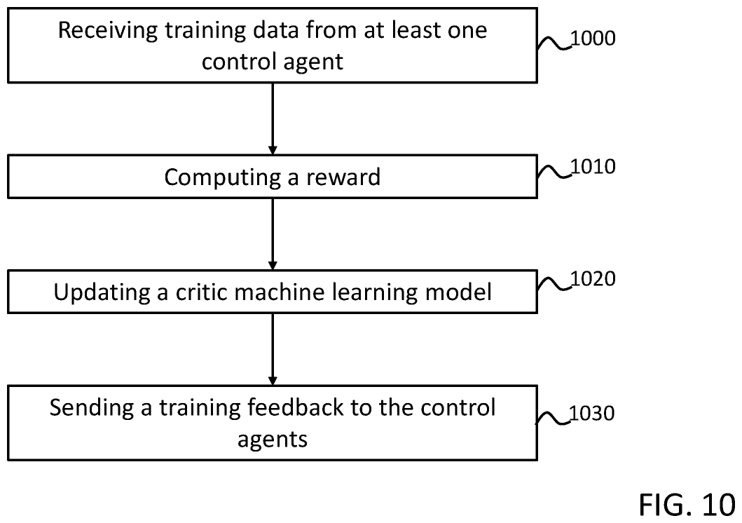

FIG. 10 shows a flow chart of a method performed by a training host. The training host may be associated with a plurality of protocol agents participating to a multiagent reinforcement learning process. The protocol agents may be MAC agents.

At step 1000, training data from at least one protocol agent are received. The training data may include state vectors. The training data may include one or more control plane actions predicted by a machine learning model at the protocol agent.

At step 1010, a reward is computed on the basis of one or more control plane actions predicted respectively by the protocol agents.

At step 1020, a critic machine learning model is updated based on the reward and the state vectors. The critic machine learning model may be configured to generate an expected quality value based on the training data.

At step 1030, a training feedback is sent to the protocol agents. The training feedback may include the expected quality value and/or the reward. The reward may be based on contributions of the protocol agents. A contribution to the reward of a protocol agent may be computed based on a reward function that increases as a function of a goodput achieved by user plane transmissions through the communication medium.

### Performance Results

Performance results were obtained in a system with uniform traffic arrival probability, where each UE starts with an empty transmission buffer empty and the arrival probability of the packet is pₐᵣᵣᵢᵥₐₗ. The MAC agents also keep as past history the last 3 observations, messages received and actions taken. This past history together with the current messages received and the current observation form an agent's state (input of the MAC learner). The learning algorithm is the Multi-Agent Deep Deterministic Policy Gradient (MADDPG). The duration of an episode is fixed at 24 TTIs.

The baseline solutions are a contention-free protocol and a contention-based protocol. The proposed solution is tested both on BS side and on UE side.

In the contention-based protocol has a fixed probability of transmission and the UEs delete a package only when receiving an ACK (acknowledgement) from the BS.

In the contention-free protocol, upon receiving an SR (sending request), the BS send an SG (sending grant) to the UE and in case of more than one requester the BS chooses the UE randomly. Upon receiving a transmission, the BS sends an ACK to the UE. If the BS receives a transmission and a SR from the same UE, it ignores the SR and sends the ACK.

In the proposed solution based on an ML model interpreting the actions of a BS in an action space including three downlink signalling actions, the BS MAC model outputs a signalling action that are interpreted by the UEs as:
1. s_{DL}=0: Do not transmit on the next TII
2. s_{DL}=1: SG: Transmit in the next TTI
3. s_{DL}=2: send an ACK.

For the UE, if the UE receives a SG and did not transmit in the previous TTI, the UE transmits the next buffered MAC PDU. If the UE received an ACK, it removes a MAC PDU from the uplink buffer.

In the proposed solution based on an ML model interpreting the actions of a UE in an action space including two uplink signalling actions, the UE MAC model generates an uplink signalling action that is interpreted by the BS as:
1. s_{UL}=0: Nothing
2. s_{UL}=1: Send a SR

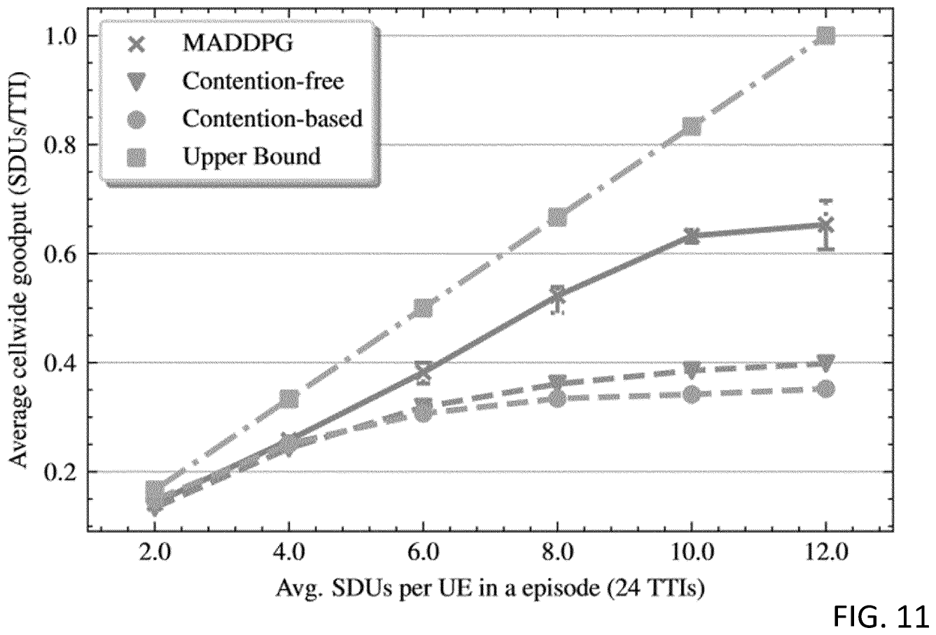

FIG. 11 shows the performance evaluation of the emerged protocol compared with the baselines for different traffic scenarios with 2 UEs having different arrival probabilities pₐᵣᵣᵢᵥₐₗ.

The upper bound show the performance assuming that all SDUs are received. The proposed method for emerging a MAC protocol achieves a much better goodput then the baselines in higher traffic scenarios with an improvement of more than 50%.

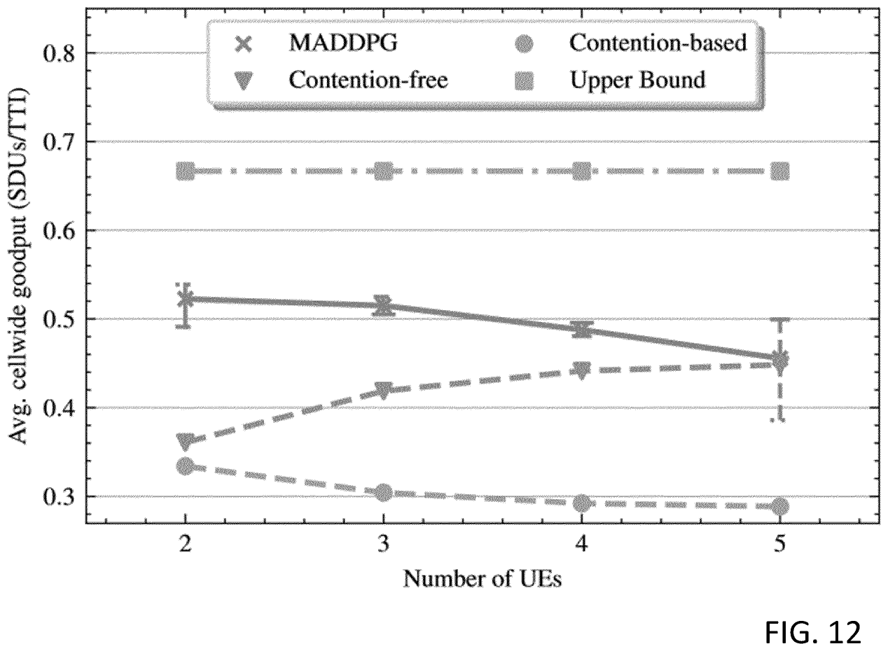

FIG. 12 shows performance evaluation of the emerged protocol compared with the baselines for different number of UEs scenarios.

The results in FIG. 12 show the performance of the emerged protocol in scenarios where the total cell wide average arrival rate is fixed, but the number of UEs is different. The results show that the proposed method produces protocols that are able to cope with increased number of UEs while providing better goodput than the baselines.

It should be appreciated by those skilled in the art that any functions, engines, block diagrams, flow diagrams, state transition diagrams, flowchart and/or data structures described herein represent conceptual views of illustrative circuitry embodying the principles of the invention. Similarly, it will be appreciated that any flow charts, flow diagrams, state transition diagrams, pseudo code, and the like represent various processes which may be substantially represented in computer readable medium and so executed by a computer or processing apparatus, whether or not such computer or processor is explicitly shown.

Although a flow chart may describe operations as a sequential process, many of the operations may be performed in parallel, concurrently or simultaneously. Also some operations may be omitted, combined or performed in different order. A process may be terminated when its operations are completed but may also have additional steps not disclosed in the figure or description. A process may correspond to a method, function, procedure, subroutine, subprogram, etc. When a process corresponds to a function, its termination may correspond to a return of the function to the calling function or the main function.

Each described function, engine, block, step described herein can be implemented in hardware, software, firmware, middleware, microcode, or any suitable combination thereof.

When implemented in software, firmware, middleware or microcode, instructions to perform the necessary tasks may be stored in a readable medium that may be or not included in a host apparatus or system. The instructions may be transmitted over the readable medium and be loaded onto the host apparatus or system. The instructions are configured to cause the host apparatus or system to perform one or more functions disclosed herein. For example, as mentioned above, according to one or more examples, at least one memory may include or store instructions, the at least one memory and the instructions may be configured to, with at least one processor, cause the host apparatus/system to perform the one or more functions. Additionally, the processor, memory and instructions, serve as means for providing or causing performance by the host apparatus/system of one or more functions disclosed herein.

The host apparatus or system may be a general-purpose computer and/or computing system, a special purpose computer and/ r computing system, a programmable processing apparatus and/or system, a machine, etc. The host apparatus or system may be or include or be part of: a user equipment, client device, mobile phone, laptop, computer, network element, data server, network resource controller, network apparatus, router, gateway, network node, computer, cloud-based server, web server, application server, proxy server, etc.

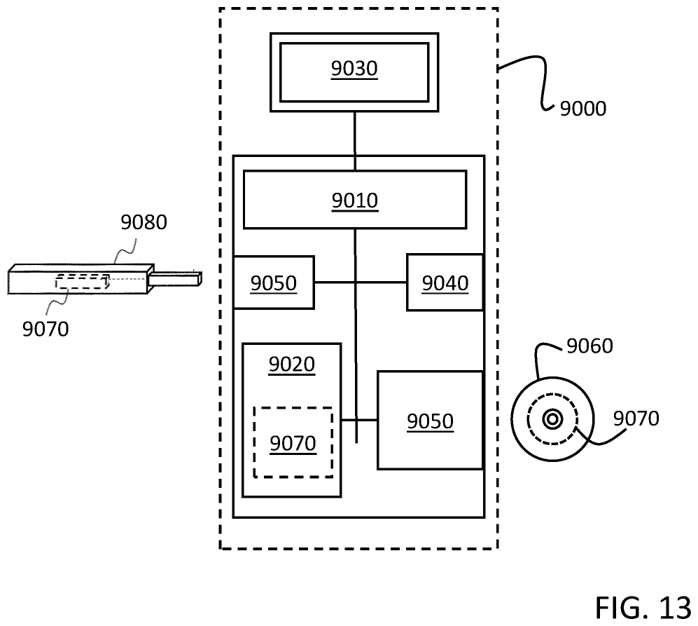

FIG. 13 illustrates an example of an apparatus 9000. The apparatus may include a training host or a network node as disclosed herein.

As represented schematically by FIG. 13, the apparatus 9000 may include at least one processor 9010 and at least one memory 9020. The apparatus 9000 may include one or more communication interfaces 9040 (e.g. network interfaces for access to a wired/wireless network, including Ethernet interface, WIFI interface, etc) connected to the processor and configured to communicate via wired/non wired communication link(s). The apparatus 9000 may include user interfaces 9030 (e.g. keyboard, mouse, display screen, etc) connected with the processor. The apparatus 9000 may further include one or more media drives 9050 for reading a computer-readable storage medium (e.g. digital storage disc 9060 (CD-ROM, DVD, Blue Ray, etc), USB key 9080, etc). The processor 9010 is connected to each of the other components 9020, 9030, 9040, 9050 in order to control operation thereof.

The memory 9020 may include a random access memory (RAM), cache memory, non-volatile memory, backup memory (e.g., programmable or flash memories), read-only memory (ROM), a hard disk drive (HDD), a solid state drive (SSD) or any combination thereof. The ROM of the memory 9020 may be configured to store, amongst other things, an operating system of the apparatus 9000 and/or one or more computer program code of one or more software applications. The RAM of the memory 9020 may be used by the processor 9010 for the temporary storage of data.

The processor 9010 may be configured to store, read, load, execute and/or otherwise process instructions 9070 stored in a computer-readable storage medium 9060, 9080 and/or in the memory 9020 such that, when the instructions are executed by the processor, causes the apparatus 9000 to perform one or more or all steps of a method described herein for the concerned apparatus 9000.

The instructions may correspond to program instructions or computer program code. The instructions may include one or more code segments. A code segment may represent a procedure, function, subprogram, program, routine, subroutine, module, software package, class, or any combination of instructions, data structures or program statements. A code segment may be coupled to another code segment or a hardware circuit by passing and/or receiving information, data, arguments, parameters or memory contents. Information, arguments, parameters, data, etc. may be passed, forwarded, or transmitted via any suitable technique including memory sharing, message passing, token passing, network transmission, etc.

When provided by a processor, the functions may be provided by a single dedicated processor, by a single shared processor, or by a plurality of individual processors, some of which may be shared. The term “processor” should not be construed to refer exclusively to hardware capable of executing software and may implicitly include one or more processing circuits, whether programmable or not. A processor or likewise a processing circuit may correspond to a digital signal processor (DSP), a network processor, an application specific integrated circuit (ASIC), a field programmable gate array (FPGA), a System-on-Chips (SoC), a Central Processing Unit (CPU), an arithmetic logic unit (ALU), a programmable logic unit (PLU), a processing core, a programmable logic, a microprocessor, a controller, a microcontroller, a microcomputer, a quantum processor, any device capable of responding to and/or executing instructions in a defined manner and/or according to a defined logic. Other hardware, conventional or custom, may also be included. A processor or processing circuit may be configured to execute instructions adapted for causing the host apparatus or host system to perform one or more functions disclosed herein for the host apparatus or host system.

A computer readable medium or computer readable storage medium may be any tangible storage medium suitable for storing instructions readable by a computer or a processor. A computer readable medium may be more generally any storage medium capable of storing and/or containing and/or carrying instructions and/or data. The computer readable medium may be a non-transitory computer readable medium. The term “non-transitory”, as used herein, is a limitation of the medium itself (i.e., tangible, not a signal) as opposed to a limitation on data storage persistency (e.g., RAM vs. ROM).

A computer-readable medium may be a portable or fixed storage medium. A computer readable medium may include one or more storage device like a permanent mass storage device, magnetic storage medium, optical storage medium, digital storage disc (CD-ROM, DVD, Blue Ray, etc), USB key or dongle or peripheral, a memory suitable for storing instructions readable by a computer or a processor.

A memory suitable for storing instructions readable by a computer or a processor may be for example: read only memory (ROM), a permanent mass storage device such as a disk drive, a hard disk drive (HDD), a solid state drive (SSD), a memory card, a core memory, a flash memory, or any combination thereof.

In the present description, the wording “means configured to perform one or more functions” or “means for performing one or more functions” may correspond to one or more functional blocks comprising circuitry that is adapted for performing or configured to perform the concerned function(s). The block may perform itself this function or may cooperate and/or communicate with other one or more blocks to perform this function. The “means” may correspond to or be implemented as “one or more modules”, “one or more devices”, “one or more units”, etc. The means may include at least one processor and at least one memory including computer program code, wherein the at least one memory and the computer program code are configured to, with the at least one processor, cause an apparatus or system to perform the concerned function(s).

As used in this application, the term “circuitry” may refer to one or more or all of the following:
(a) hardware-only circuit implementations (such as implementations in only analog and/or digital circuitry) and
(b) combinations of hardware circuits and software, such as (as applicable): (i) a combination of analog and/or digital hardware circuit(s) with software/firmware and (ii) any portions of hardware processor(s) with software (including digital signal processor(s)), software, and memory(ies) that work together to cause an apparatus, such as a mobile phone or server, to perform various functions); and
(c) hardware circuit(s) and or processor(s), such as a microprocessor(s) or a portion of a microprocessor(s), that requires software (e.g., firmware) for operation, but the software may not be present when it is not needed for operation.”

This definition of circuitry applies to all uses of this term in this application, including in any claims. As a further example, as used in this application, the term circuitry also covers an implementation of merely a hardware circuit or processor (or multiple processors) or portion of a hardware circuit or processor and its (or their) accompanying software and/or firmware. The term circuitry also covers, for example and if applicable to the particular claim element, an integrated circuit for a network element or network node or any other computing device or network device.

The term circuitry may cover digital signal processor (DSP) hardware, network processor, application specific integrated circuit (ASIC), field programmable gate array (FPGA), etc. The circuitry may be or include, for example, hardware, programmable logic, a programmable processor that executes software or firmware, and/or any combination thereof (e.g. a processor, control unit/entity, controller) to execute instructions or software and control transmission and receptions of signals, and a memory to store data and/or instructions.

The circuitry may also make decisions or determinations, generate frames, packets or messages for transmission, decode received frames or messages for further processing, and other tasks or functions described herein. The circuitry may control transmission of signals or messages over a radio network, and may control the reception of signals or messages, etc., via one or more communication networks.

Although the terms first, second, etc. may be used herein to describe various elements, these elements should not be limited by these terms. These terms are only used to distinguish one element from another. For example, a first element could be termed a second element, and similarly, a second element could be termed a first element, without departing from the scope of this disclosure. As used herein, the term “and/or,” includes any and all combinations of one or more of the associated listed items.

The terminology used herein is for the purpose of describing particular embodiments only and is not intended to be limiting. As used herein, the singular forms “a,” “an,” and “the,” are intended to include the plural forms as well, unless the context clearly indicates otherwise. It will be further understood that the terms “comprises,” “comprising,” “includes,” and/or “including,” when used herein, specify the presence of stated features, integers, steps, operations, elements, and/or components, but do not preclude the presence or addition of one or more other features, integers, steps, operations, elements, components, and/or groups thereof.

While aspects of the present disclosure have been particularly shown and described with reference to the embodiments above, it will be understood by those skilled in the art that various additional embodiments may be contemplated by the modification of the disclosed machines, systems and methods without departing from the scope of what is disclosed. Such embodiments should be understood to fall within the scope of the present disclosure as determined based upon the claims and any equivalents thereof.

### LIST OF ABBREVIATIONS

ACK Acknowledgement
AI-AI AI-based Air Interface
API Application Programming Interface
BS Base Station
CSI Channel State Information
CTDE Centralized Training Decentralized Execution
HARQ Hybrid Automatic Repeat Request
MAC Medium Access Control
MADDPG Multi-Agent Deep Deterministic Policy Gradient
MADRL Multi-Agent Deep Reinforcement Learning
MAPPO Multi-Agent Proximal Policy Optimization
MDP Markov Decision Process
ML Machine Learning
PDCCH Physical Downlink Control Channel
PDSCH Physical Downlink Shared Channel
PDU Protocol Data Unit
PUCCH Physical Uplink Control Channel
PUSCH Physical Uplink Shared Channel
RACH Random Access Channel
RL Reinforcement Learning
RLC Radio Link Control
RRC Radio Resource Control
RSRP Reference Signal Received Power
RSRQ Reference Signal Received Quality
SDLC Software Development Life Cycle
SDU Service Data Unit
SG Scheduling Grant
SR Scheduling Request
TTI Transmission Time Interval
UE User Equipment
ULSCH Uplink Shared Channel
URLLC Ultra Reliable Low Latency Communications

1. A method comprising:
training a machine learning model to learn a communication protocol for a communication medium by assigning a function to control plane actions in a set of control plane actions, wherein the communication protocol defines control-plane messages to be transmitted via the communication medium and a user-plane policy;
wherein the machine learning model is configured to identify, in the set of control plane actions, a control plane action to be performed during a current transmission time interval by a protocol agent at a network node.

2. The method according to claim 1, wherein the communication protocol is a medium access control, MAC, protocol and the protocol agent is a MAC agent.

3. The method according to claim 1, wherein the machine learning model is configured to identify the control plane action on the basis of at least on an observation vector obtained for a current transmission time interval.

4. The method according to claim 1, wherein the machine learning model is configured to identify the control plane action on the basis of one or more control plane messages received from another MAC agent at another network node.

5. The method according to claim 1, wherein training the machine learning model comprises
receiving from a training host a training feedback for a next transmission time interval;
updating coefficients of the machine learning model based on the training feedback.

6. The method according to claim 5, wherein the training feedback includes a reward based on contributions of other protocol agents participating with the protocol agent to a multiagent reinforcement learning process, wherein a reward contribution of a protocol agent is computed based on a reward function that increases as a function of a goodput achieved by user plane transmissions through the communication medium.

7. The method according to claim 6, wherein the contribution to the reward of an agent implemented by a user equipment is set for a given transmission time interval and an uplink:
to a positive reward amount when an uplink data packet is received from the user equipment by a base station in response to a previous downlink control plane message;
to a negative reward amount when a user equipment deletes a data packet from its transmission buffer if the data packet has not yet been received by the base station;
to zero otherwise.

8. The method according to claim 6, wherein the contribution to the reward of an agent implemented by a user equipment is set for a given transmission time interval and a downlink:
to a positive reward amount when a downlink data packet is received from a base station by a user equipment in response to a previous uplink control plane message;
to a negative reward amount when a base station deletes a data packet from its transmission buffer when the data packet has not yet been received by the user equipment;
to zero otherwise.

9. The method according to claim 1, wherein the machine learning model is configured to identify in a set of a user plane actions a next user plane action to be performed by the agent on a physical layer on the basis at least of the observation vector.

10. The method according to claim 1, wherein the number of control plane actions in the set of control plane actions is defined as a function of a number of user equipments associated with the network node and a number of types of control plane messages.

11. The method according to claim 1, comprising
sending training data to the training host, the training data including one or more observation vectors and/or one or more control plane actions identified by the machine learning model based on the one or more observation vectors and/or one or more user plane actions identified by the machine learning model based on the one or more observation vectors.

12. A method for a training host associated with a plurality of protocol agents participating to a multiagent reinforcement learning process, the method comprising:
receiving training data from at least one protocol agent, the training data including state vectors and one or more control plane actions predicted by a machine learning model at the protocol agent;
computing a reward on the basis of one or more control plane actions predicted respectively by the protocol agents;
updating a critic machine learning model based on the reward and the state vectors, wherein the critic machine learning model is configured to generate an expected quality value based on the training data;
sending a training feedback to the protocol agents, wherein the training feedback includes at least one of the expected quality value and the reward.

13. The method according to claim 12, wherein the reward is based on contributions of the protocol agents, wherein a reward contribution of a protocol agent is computed based on a reward function that increases as a function of a goodput achieved by user plane transmissions through the communication medium.

14. An apparatus, comprising:
at least one processor; and
at least one memory storing instructions that, when executed by the at least one processor, caused the apparatus to perform at least
receiving training data from at least one protocol agent, the training data including state vectors and one or more control plane actions predicted by a machine learning model at the protocol agent;
computing a reward on the basis of one or more control plane actions predicted respectively by the protocol agents;
updating a critic machine learning model based on the reward and the state vectors, wherein the critic machine learning model is configured to generate an expected quality value based on the training data;
sending a training feedback to one or more protocol agents at one or more network nodes, wherein the training feedback includes at least one of the expected quality value and the reward; and
training a machine learning model to learn a communication protocol for a communication medium by assigning a function to control plane actions defined in a set of control plane actions, wherein the protocol defines control-plane messages to be transmitted via the communication medium and a user-plane policy;
wherein the machine learning model is configured to identify, in the set of control plane actions, a control plane action to be performed during a current transmission time interval by a protocol agent at a network node.

15. (canceled)
